(19) United States
(12) Patent Application Publication
(10) Pub. No.: US 2022/0105744 A1
(43) Pub. Date: Apr. 7, 2022

(54) PEN AND PENCIL CONTAINER

(71) Applicant: Yingzhe Fu, Dublin, CA (US)

(72) Inventor: Yingzhe Fu, Dublin, CA (US)

(21) Appl. No.: 17/063,408

(22) Filed: Oct. 5, 2020

(51) Int. Cl. B43M 99/00

(52) U.S. Cl. CPC B43M 99/008

(57) ABSTRACT

An organizer for pens, pencils, markers, erasers, rulers or any other suitable office supplies having a transparent construction and the ability to stand on a desk or be mounted on a wall.

### BACKGROUND

### 1. Field

One or more embodiments of the present invention relate to a novel organizer for holding and storing writing implements such as pens, pencils, erasers, rulers, and markers. The new and improved pen and pencil container can be hung on a wall, stored or placed on any flat surface, or stored in a drawer or cabinet. The wedge shape of the pen and pencil container allows for ease of adding and removing items.

### 2. Description of the Related Art

Current containers that are configured to hold writing implements, such as pens, pencils and markers are often constructed of materials that obscure the identity of the items inside the container. These simple pen and pencil containers were typically cups reconfigured to hold writing implements. The lack of transparency makes it difficult for a user to select the desired implement without searching and picking many undesired implements before arriving at the desired pen or pencil.

Also, previous attempts at constructing pen and pencil containers have focused on desktop or tabletop cups or boxes. Many space saving office designs do not provide adequate desktop space for such storage containers. Also, current pen and pencil container shapes only permit them to stand on flat surfaces. Most are not able to be placed in desk drawers either due to their height or shape. If a user moves to an office setup without adequate flat desk space, the container becomes useless.

Therefore, what is needed is a writing implement container for organizing pens, pencils, and markers that can be placed on a table, hung on a wall, or stored in a drawer or cabinet, which is constructed of a material that is transparent enough to allow the user to see the items within.

### SUMMARY

One or more embodiments of the present invention provide a writing implement container or pen and pencil container constructed of a transparent material that is configured to be mounted on a wall or positioned upright on a desk or table. The present writing implement container comprises dimensions that allow the container to be stored upright in a drawer or cabinet.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic depiction of the front view and partial top view of the pen and pencil container.

FIG. 2 is a schematic depiction of the front view of the pen and pencil container of FIG. 1.

FIG. 3 is a bottom view of the pen and pencil container of FIG. 1.

FIG. 4 is a side view of the pen and pencil container of FIG. 1.

FIG. 5 is a schematic depiction of the front view and side view of the pen and pencil container of FIG. 1 with a push pin.

FIG. 6 is a rear view of the pen and pencil container of FIG. 1 with a push pin.

FIG. 7 is another side view of the pen and pencil container of FIG. 1 with a push pin.

FIG. 8 is a front view of the pen and pencil container of FIG. 1 with a push pin.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present invention.

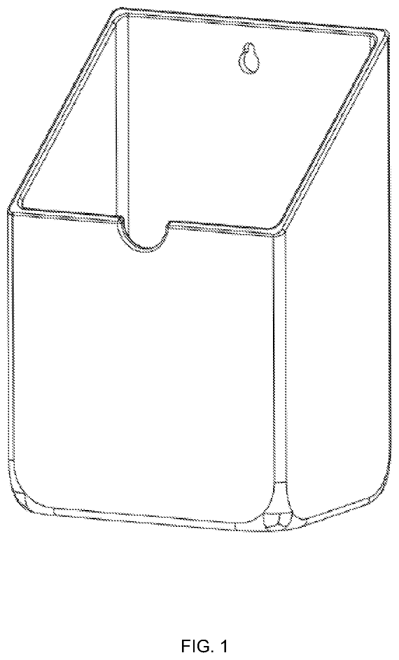

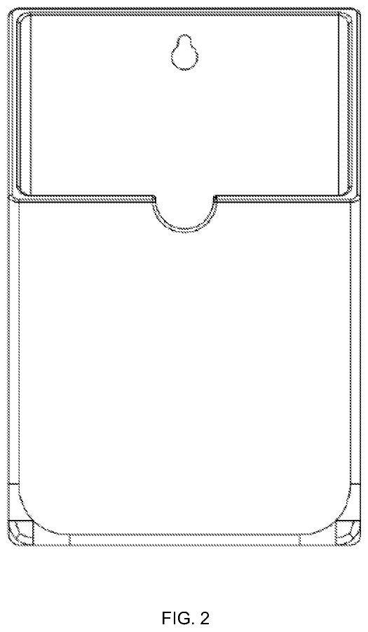

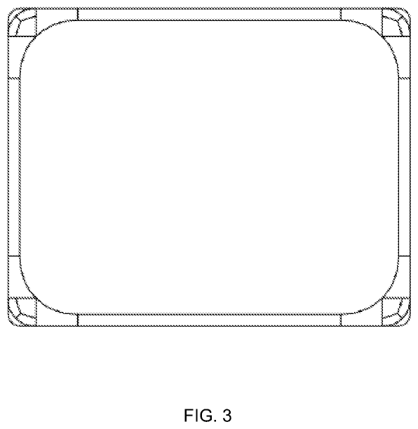

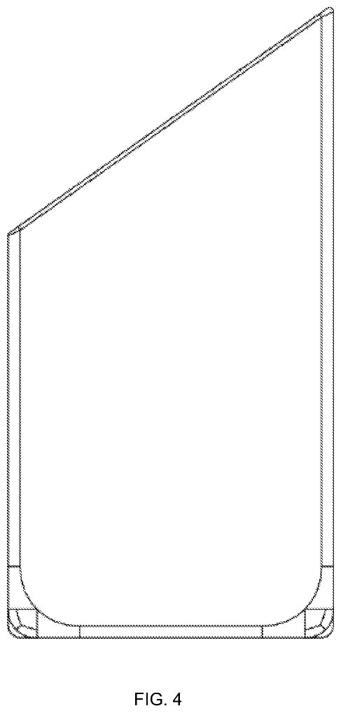

As depicted in FIGS. 1-4, the writing implement container of the present invention placed on the table, but also can be placed in the drawer or cabinet if the drawer or cabinet has enough room to contain the organizer. The container is not limited to use in the office but can also be used in any other situation in which it can assist in the organization of items.

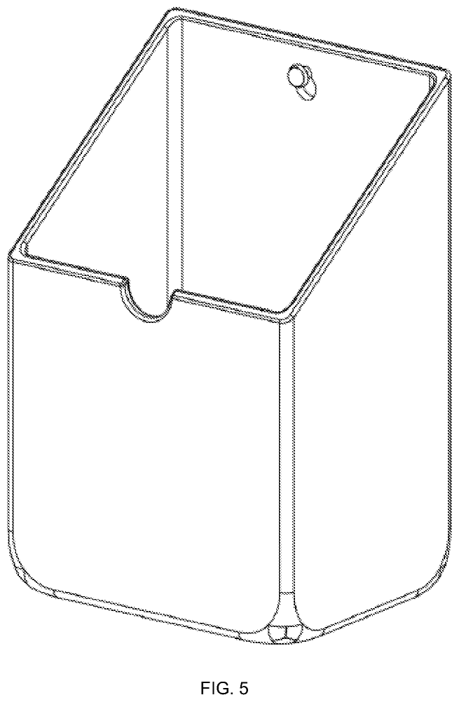

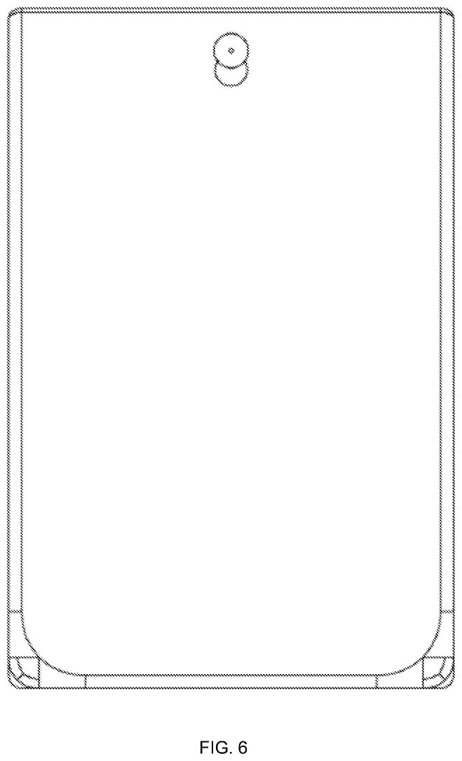

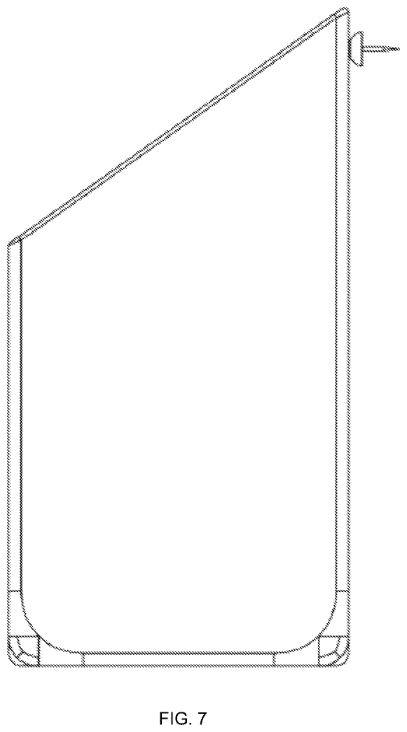

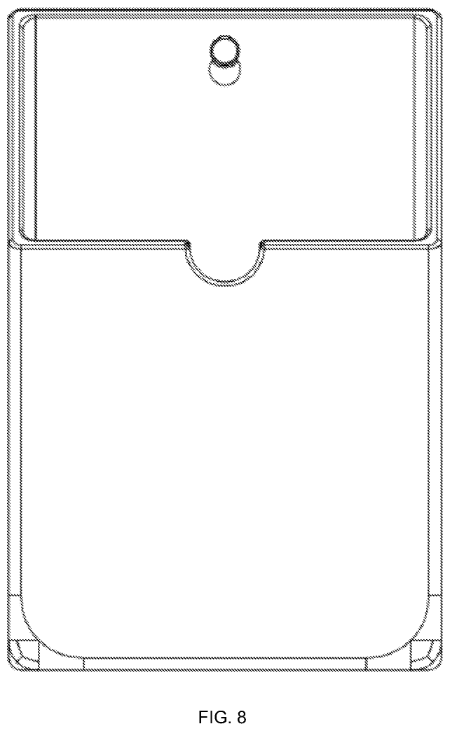

The writing implement container has a wedged shape opening on the top with at least a 35° sledding slope, and preferably with a 35.27° sledding slope. The organizer's four corners at its base are fully rounded corners, which makes the corners blend into the container's body. The edges of the container are all fillet edges, which provides a comfort grip feeling. The shape of the container reflects a minimalist, clean and simple design style. The container not only can be placed on the top of table surface but can also be hung on the wall using the keyhole feature on the container's body shown in FIGS. 5-8. The user can use regular push pins to hang the organizer on the wall or board. The organizer is constructed of transparent plastic, which allows user to see through the container. The transparent plastic has a wall thickness of 3 mm to 5 mm. In a preferred embodiment, the transparent plastic walls have a thickness of 3.5 mm.

1. A writing implement storage container for wall mounting or desktop placement comprising a container having a base portion and side walls with edges; wherein the edges of the container are all fillet edges.

2. The writing implement storage container of claim 1 wherein the container has a wedge shape opening on the top with at least a 35° sledding slope.

3. The writing implement storage container of claim 2 wherein the container base and side walls are comprised of transparent plastic.

4. The writing implement storage container of claim 3 wherein the rear wall comprises a keyhole feature.

5. The writing implement storage container of claim 3 wherein the transparent plastic has a thickness in the range of 3.0 mm to 5.0 mm.

6. The writing implement storage container of claim 5 wherein the transparent plastic has a thickness of 3.5 mm.
